(19) United States
(12) Patent Application Publication
(10) Pub. No.: US 2025/0060864 A1
(43) Pub. Date: Feb. 20, 2025

(54) GRAPHICAL USER INTERFACE FOR PROVIDING AUTOMATED, REAL-TIME INTERACTIVE WORD PROCESSING ASSISTANCE TO A USER

(71) Applicant: Certara, L.P., Wilmington, DE (US)

(72) Inventor: Christopher Bouton, Newbury, MA (US)

(21) Appl. No.: 18/804,930

(22) Filed: Aug. 14, 2024

Related U.S. Application Data
(60) Provisional application No. 63/660,449, filed on Jun. 14, 2024.
(60) Provisional application No. 63/533,274, filed on Aug. 17, 2023.

(51) Int. Cl. G06F 3/0484; G06F 3/0482; G06F 9/451; G06F 40/166

(52) U.S. Cl. CPC G06F 3/0484; G06F 3/0482; G06F 9/453; G06F 40/166; G06F 2203/04803

(57) ABSTRACT

Presented herein are interactive graphical user interfaces (GUIs) for providing automated, real-time interactive assistance to a human user creating electronic documents. In certain embodiments, the GUI includes an alphanumeric text processing region, an AI-generated text region, and a reference list region. The AI-generated text region contains one or more alternative blocks of text responsive to a user query and based on specific references (e.g., articles, books, or other written works). The references are listed in the reference list region of the GUI.

### PRIORITY APPLICATIONS

This application claims the benefit of U.S. Patent Application No. 63/533,274, filed Aug. 17, 2023, and U.S. Patent Application No. 63/660,449, filed Jun. 14, 2024, the disclosure of each of which is hereby incorporated by reference herein in its entirety.

### FIELD

This invention relates generally to artificial intelligence (AI) tools for use in interactive word processing applications.

### BACKGROUND

Natural language processing models (NLPs) such as generative pre-trained transformers (GPTs) are revolutionizing word processing tasks. Current models such as GPTs have weaknesses when used independently, particularly for the creation and/or editing of highly technical electronic documents such as clinical study reports (CSRs), scientific journal articles, legal briefs, and the like. For example, GPTs are prone to “hallucinating” data and/or references, and third party GPTs lack the security needed when working with proprietary data.

There is a need for smarter AI tools for assisting human writers in the creation and editing of electronic documents.

### SUMMARY

Presented herein are interactive graphical user interfaces (GUIs) for providing automated, real-time interactive assistance to a human user creating electronic documents. In certain embodiments, the GUI includes an alphanumeric text processing region, an AI-generated text region, and a reference list region. The AI-generated text region contains one or more alternative blocks of text responsive to a user query and based on specific references (e.g., articles, books, or other written works). The references are listed in the reference list region of the GUI.

For example, FIG. 1 shows a schematic of a constructive example GUI 100 that a user may interact with to create an electronic document. In this example, while a user creates and/or edits an electronic document in a word processing region of the GUI 100, the user may enter a query or command to request information from a database of publicly available and/or proprietary sources. The information is provided by artificial intelligence (AI) software that incorporates, for example, one or more large language models (LLMs) to produce alternative blocks of alphanumeric text based on specific references identified in the database. The query may be entered by the user, for example, as alphanumeric text in the form of a question or command received via a dialog box and/or as a selection of one or more entries of a drop-down menu, radio button list, or other graphical user interface element/widget. The processor receives the user query via the GUI, produces the alternative blocks of text in response to the query based on specific references, and renders and/or displays the blocks of text in the AI-generated text region of the GUI.

In this way, the AI-generated blocks of text are presented for convenient selection, copying, pasting, and/or editing by the user and incorporation into the electronic document viewed in the word processing region of the GUI. Moreover, the AI-generated blocks of text are clearly and visually linked to corresponding references from which they were created and/or upon which they are based. In certain embodiments, the user may click on a specific reference to confirm the accuracy, tone, level of detail, and/or other attributes of the AI-generated text based on that reference.

In an aspect, the present invention is directed to a method for providing automated, real-time interactive assistance to a user creating an electronic document via a graphical user interface (GUI), the method comprising: receiving, by a processor of a computing device, a user query (e.g., wherein the user query comprises alphanumeric text in the form of a question or command received via a dialog box, and/or wherein the user query comprises a selection of one or more entries of a drop-down menu, radio button list, or other graphical user interface element/widget); rendering, and/or displaying on a screen, the graphical user interface (GUI), said GUI comprising at least three separate regions (e.g., at least three panels or other graphical elements/widgets separated by lines or otherwise separated spatially from each other), said at least three regions comprising: an alphanumeric text processing region (e.g., a content view panel or window, e.g., a word processing active drafting panel) for use by the user in creating and/or editing content of the electronic document within said alphanumeric text processing region, an artificial intelligence (AI)-generated text region (e.g., an AI prompting user interface region) for presenting to the user, in response to the user query, one or more user-selectable alternative blocks of alphanumeric text generated in whole or in part by artificial intelligence (AI) [e.g., generative AI software comprising or accessing one or more foundational models, e.g., large language models (LLMs), said one or more foundational models pre-trained on a large body of data (e.g., billions or trillions of words)], each alterative block of alphanumeric text generated based at least in part on the user query and one or more known, citable reference(s) and selectable by the user for presentation within the alphanumeric text processing region (e.g., for incorporation into the electronic document and/or for further editing in the electronic document via the word processing active drafting panel), and a reference list region (e.g., a citations panel) for presenting to the user, in response to a user query, user-selectable name(s) of one or more known, citable references for possible selection by the user; accessing, by the processor, one or more databases to identify one or more known, citable references containing information responsive to the query; rendering, and/or displaying on the screen, by the processor, a list of user-selectable name(s) of the one or more identified, known, citable references within the reference list region of the GUI; receiving, by the processor, a selection from the user corresponding to one or more of the known, citable reference(s)—or one or more portions thereof—from which one or more alternative blocks of alphanumeric text are to be generated in whole or in part by artificial intelligence (AI) (e.g., identifying one or more cursor-location-associated mouse clicks, touchpad touches, or other input by the user made within the reference list region of the GUI); generating, by the processor, one or more user-selectable alternative blocks of alphanumeric text in whole or in part by artificial intelligence (AI) (AI-generated alphanumeric text) responsive to the user query, said generating based at least in part on the user-selected known, citable reference(s) or portion(s) thereof; rendering, and/or displaying on the screen, by the processor, the one or more user-selectable alternative blocks of AI-generated alphanumeric text in the AI-generated text region of the GUI; receiving, by the processor, a selection from the user corresponding to one or more of the user-selectable alternative block(s)—or one or more portion(s) thereof—of AI-generated alphanumeric text (e.g., identifying one or more cursor-location-associated mouse clicks, touchpad touches, or other input by the user made within the AI-generated text region of the GUI); and in response to selection by the user of one or more of the alternative block(s) of AI-generated alphanumeric text, or portion(s) thereof, rendering, and/or displaying on the screen, by the processor, the GUI (e.g., updated) with the one or more user-selected alternative block(s)—or the one or more user-selected portion(s) thereof—within the alphanumeric text processing region of the GUI (e.g., copying and pasting of the AI-generated text into the electronic document in the word processing active drafting panel).

In some embodiments, the user query elicits a plurality of known, citable references, and wherein the method comprises: generating, by the processor, at least one user-selectable alternative block of AI-generated alphanumeric text responsive to the query for each of the known, citable references; rendering, and/or displaying on the screen, by the processor, the list of user-selectable names of the plurality of known references in the reference list region of the GUI; and rendering and/or displaying on the screen, by the processor, the plurality of user-selectable alternative blocks of AI-generated alphanumeric text in the AI-generated text region of the GUI, wherein each said reference name is rendered and/or displayed in the GUI in graphical proximity to (e.g., and/or color coordinated with and/or otherwise graphically coordinated with) the corresponding user-selectable alternative block of AI-generated alphanumeric text (e.g., each user-selectable block of AI-generated text is rendered and/or displayed in the GUI alongside the name of the reference upon which it is based).

In some embodiments, the method comprises: receiving, by the processor, a selection from the user corresponding to a selected plurality of the known, citable reference(s) (e.g., and graphically identifying the selected plurality, e.g., by highlighting or shading the selected names of the references in the reference list region of the GUI); generating, by the processor, a user-selectable block of AI-generated alphanumeric text responsive to the user query and based (at least in part) on all of the selected plurality of known, citable references; and rendering, and/or displaying on the screen, by the processor, the user-selectable block of AI-generated alphanumeric text in the AI-generated text region of the GUI.

In some embodiments, the method comprises: generating, by the processor, for each user-selected reference in the reference list region of the GUI, a plurality of user-selectable alternative blocks of AI-generated alphanumeric text responsive to the user query and based (at least in part) on the user-selected reference (e.g., said alternative blocks representing different styles of AI-generated text blocks, different levels of detail, or the like, e.g., based on a user selection of alternative styles and/or levels of detail or the like); and rendering, and/or displaying on the screen, by the processor, the user-selectable plurality of blocks of AI-generated alphanumeric text in the AI-generated text region of the GUI.

In some embodiments, the method comprises: rendering, and/or displaying on the screen (e.g., within a separate reference text displaying window), text from a user-selected reference from the reference list; identifying, by the processor, a user-identified portion of the rendered and/or displayed text from the user-selected reference that is highlighted and/or otherwise graphically indicated by the user; generating, by the processor, one or more user-selectable blocks of AI-generated alphanumeric text responsive to the user query and based (at least in part) on the user-identified portion of the rendered and/or displayed text (e.g., to the exclusion of any non-user-identified portions of the rendered and/or displayed text); and rendering, and/or displaying on the screen, by the processor, the one or more user-selectable blocks of AI-generated alphanumeric text in the AI-generated text region of the GUI.

In some embodiments, the method comprises rendering, and/or displaying on a screen, a graphical element (e.g., a dialog box, drop down menu, radio button list, or other widget or combination of widgets) for entry of the received user query in the graphical user interface (GUI) [e.g., said graphical element appearing inside (or outside) one or more of the at least three separate regions (e.g., inside the AI-generated text region of the GUI, and/or inside the reference list region of the GUI, and/or inside the alphanumeric text processing region of the GUI)].

In some embodiments, generating, by the processor, the one or more user-selectable alternative blocks of AI-generated alphanumeric text responsive to the user query comprises using extractive question answering (Extractive QA) software.

In some embodiments, generating, by the processor, the one or more user-selectable alternative blocks of AI-generated alphanumeric text responsive to the user query comprises using natural language processing (NLP) software [e.g., including but not limited to generative AI software, e.g., ChatGPT and/or proprietary generative AI software].

In some embodiments, generating, by the processor, the one or more user-selectable alternative blocks of AI-generated alphanumeric text responsive to the user query comprises using one or more large language models (LLMs) [e.g., wherein the one or more LLMs comprise(s) one or more members selected from the group consisting of: BERT (Google) (or other transformer-based models), Falcon 40B, Galactica, GPT-3 (Generative Pre-trained Transformer, OpenAI), GPT-3.5 (OpenAI), GPT-4 (OpenAI), LaMDA (language model for dialogue applications, Google), Llama (large language model Meta AI) (Meta), Orca LLM (Microsoft), PaLM (Pathways Language Model), Phi-1 (Microsoft), StableLM (Stability AI), BLOOM (Hugging Face), ROBERTa (Meta), XLM-ROBERTa (Meta), NeMO LLM (Nvidia), XLNet (Google), Generate (Cohere), GLM-130B (Hugging Face), and Claude (Anthropic)] [e.g., wherein the one or more LLMs comprise(s) one or more members selected from the group consisting of an autoregressive LLM, autoencoding LLM, encoder-decoder LLM, bidirectional LLM, Fine-tuned LLMs, and multimodal LLMs].

In some embodiments, the electronic document is a clinical study report (CSR).

In another aspect, the present invention is directed to a system comprising a processor of a computing device and memory having instructions stored thereon, which, when executed by the processor, cause the processor to perform any of the methods described herein.

### BRIEF DESCRIPTION OF THE DRAWINGS

The present teachings described herein will be more fully understood from the following description of various illustrative embodiments, when read together with the accompanying drawings. It should be understood that the drawing described below is for illustration purposes only and is not intended to limit the scope of the present teachings in any way. The foregoing and other objects, aspects, features, and advantages of the disclosure will become more apparent and may be better understood by referring to the following description taken in conjunction with the accompanying drawings, in which:

FIG. 1 is a schematic that represents a screenshot of a graphical user interface (GUI) for providing automated, real-time interactive assistance to a user creating an electronic document, according to an illustrative embodiment. The schematic in FIG. 1 shows various regions of the GUI, including an alphanumeric text processing region, an artificial intelligence (AI)-generated text region, and a reference list region.

FIG. 2 is a schematic of a GUI for providing automated, real-time interactive assistance to a user in creating an electronic document, according to an illustrative embodiment. The GUI in FIG. 2 has an alphanumeric text processing region, an artificial intelligence (AI)-generated text region, and a reference list region, which are displayed in a spatially separated (and separately moveable) fashion rather than as a consolidated window as in FIG. 1.

FIG. 3 is a schematic of a GUI for providing automated, real-time interactive assistance to a user in creating an electronic document, according to an illustrative embodiment. In the schematic in FIG. 3, the alphanumeric text processing region, the artificial intelligence (AI)-generated text region, and the reference list region are displayed according to a horizontal layout.

FIG. 4 is a block flow diagram showing an example process for automated, real-time interactive assistance to a user creating an electronic document, according to an illustrative embodiment.

FIG. 5 is a schematic that represents a screenshot of a GUI in which the AI-generated alphanumeric text output presented in the AI-generated text region of the GUI is based on all of the user-selected plurality of references displayed in the reference list region of the GUI, according to an illustrative embodiment.

FIG. 6 is a schematic that represents a screenshot of a GUI in which a plurality of automatically-generated alternative AI-generated alphanumeric text blocks are presented in the AI-generated text region of the GUI based on a selected reference from the list of references presented in the reference list region of the GUI, according to an illustrative embodiment.

FIG. 7 is a schematic that represents a screenshot of a GUI in which the AI-generated alphanumeric text output presented in the AI-generated text region of the GUI is based on a user-identified portion of text in a reference selected by the user from the list of references presented in the reference list region of the GUI, according to an illustrative embodiment.

FIG. 8 is a schematic that represents a screenshot of a GUI in which the AI-generated alphanumeric text is rated by the user, according to an illustrative embodiment.

FIG. 9 is a schematic that represents a screenshot of a GUI in which a user-selected reference is searched in response to a user query and the alphanumeric text portions of the reference identified in the search can be saved in both the artificial intelligence (AI)-generated text region, and a reference list region of the GUI, according to an illustrative embodiment.

FIG. 10 is a schematic showing an illustrative implementation of a network environment for use in providing systems, methods, and architectures as described herein.

FIG. 11 is a schematic showing an illustrative network environment for use in providing systems, methods, and architectures as described herein.

FIGS. 12 to 20 show screenshots of graphical user interfaces (GUIs, e.g., windows) of an illustrative system for providing automated, real-time interactive assistance to a user creating an electronic document via a GUI, according to an illustrative embodiment.

### DETAILED DESCRIPTION

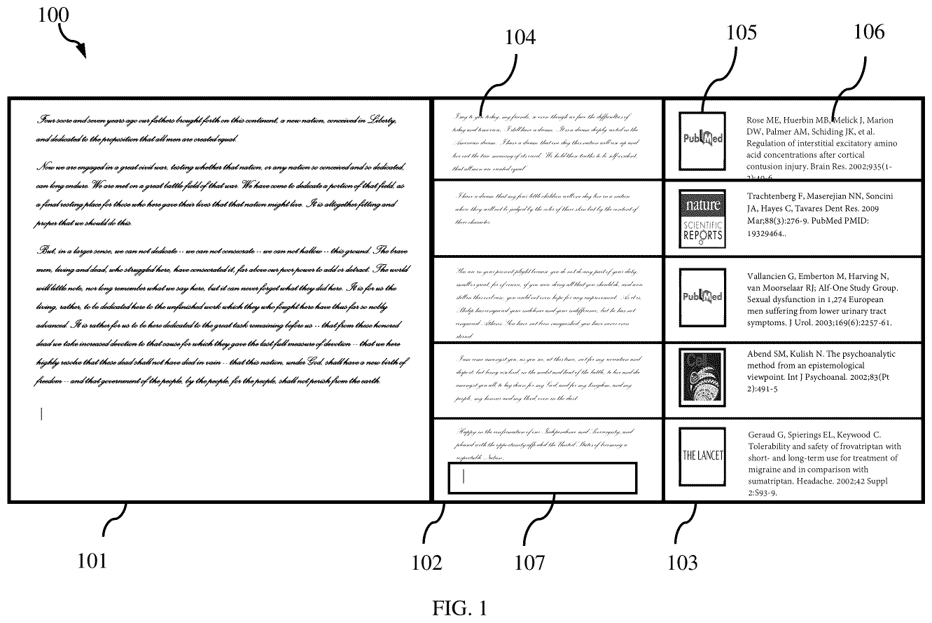

In certain embodiments, systems and methods described herein are directed to interactive tools, such as GUIs, that provide automated, real-time interactive assistance to a user creating electronic documents. For example, FIG. 1 shows a schematic of a constructive example GUI 100 that a user may interact with to create an electronic document. For example, as a user types an electronic document in a word processing region of the GUI 100, the user may enter a query or command to request information from a database of publicly available and/or proprietary sources. The information is provided by artificial intelligence (AI) software that includes/utilizes, for example, one or more large language models (LLMs) to produce alternative blocks of alphanumeric text based on specific references identified in the database. The query may be provided, for example, as alphanumeric text in the form of a question or command received via a dialog box and/or as a selection of one or more entries of a drop-down menu, radio button list, or other graphical user interface element/widget. The processor receives the user query via the GUI, produces the alternative blocks of text in response to the query based on specific references, and renders and/or displays the blocks of text in the AI-generated text region of the GUI. The alternative blocks of AI-generated text can then be reviewed by the user and selected for inclusion in the active electronic document being created/edited in the word processing region of the GUI.

### [Three (or More)-Panel GUI]

As shown in FIG. 1, the GUI 100 (and, correspondingly, 200, 300, 500, 600, 700, 800, and 900) may comprise at least three separate regions, such as panels, windows, or other graphical elements/widgets, e.g., that are graphically/spatially separated from each other on a rendered/displayed screen, e.g., that are separated by borders, lines, spaces, or other demarcations. For example, the GUI 100 may include (e.g., as a first region) an alphanumeric text processing region 101 (and, correspondingly, 201, 301, 501, 601, 701, 801, and 901) to be utilized by a user for the purpose of creating and/or editing content of an active electronic document as it is displayed in the text processing region 101 of the GUI 100. The alphanumeric text processing region 101 may take a variety of forms, such as a content view panel or window and/or a word processing active drafting panel.

In certain embodiments, the GUI 100 may also include (e.g., as a second region) an AI-generated text region 102 (and, correspondingly, 202, 302, 502, 602, 702, 802, and 901) for presenting to the user, in response to a user query entered via a user query widget 107 (and, correspondingly, 207, 307, 507, 607, 707, and 807), one or more user-selectable alternative blocks of alphanumeric text 104 (and, correspondingly, 204, 304, 504, 604, 704, and 804) generated in whole or in part by AI. Each alternative block of the AI-generated text may be selectable by the user for presentation within the alphanumeric text processing region. For example, each block of AI-generated text may be selected by the user for incorporation into the electronic document via a cut/paste operation and/or for further editing in the electronic document via the word processing active drafting panel or a separate panel for editing the AI-generated text before it is incorporated into the active electronic document displayed in the text processing region 101 of the GUI 100. In certain embodiments, the AI-generated text is created using generative AI software comprising or accessing one or more foundational models, e.g., large language models (LLMs), pre-trained on a large body of data (e.g., billions or trillions of words). Each alterative block of alphanumeric text may be generated based at least in part on the user query and one or more known, citable reference(s).

In certain embodiments, the GUI 100 may also include (e.g., as a third region) a reference list region 103 (and, correspondingly, 203, 303, 503, 603, 703, and 803) for presenting to the user, in response to a user query, user-selectable name(s) of one or more known, citable references for possible selection by the user. The reference list may provide the context and source (e.g., a literature citation) of the AI-generated text. The reference list may also provide a user with the ability to check the source of the AI-generated text and/or to check the accuracy and/or appropriateness of the AI-generated text. For example, the reference list region 103 may name publicly accessible and/or proprietary documents, documents with unique identifiers (IDs) (e.g., PubMed IDs and/or DOIs), hyperlinks, search results, or some combination thereof. The names of the references may be represented in the reference list region 103 of the GUI 100 by icons 105 (and, correspondingly, 205, 305, 505, 605, 705, and 805) and/or citation listings 106 (and, correspondingly, 206, 306, 506, 606, 706, and 806), for example. In certain embodiments, the reference list includes selectable (e.g., clickable) links to the referenced document that present the full document or portions thereof, e.g., in a separate display window. In certain embodiments, each reference name in the reference list region 103 may be displayed in the GUI in graphical proximity to the corresponding user-selectable alternative block of AI-generated alphanumeric text (e.g., the text generated by the AI using the specific reference). In certain embodiments, graphical proximity means each user-selectable block of AI-generated text is rendered and/or displayed in the GUI alongside the name of the reference upon which it is based. In some embodiments, graphical proximity may include at least one of the following: actual graphical proximity of the reference name and corresponding AI-generated text, color coordination of the reference name and corresponding AI-generated text, other graphical coordination of the reference name and corresponding AI-generated text, or any combination of thereof.

### [Different Ways the Windows can be Displayed]

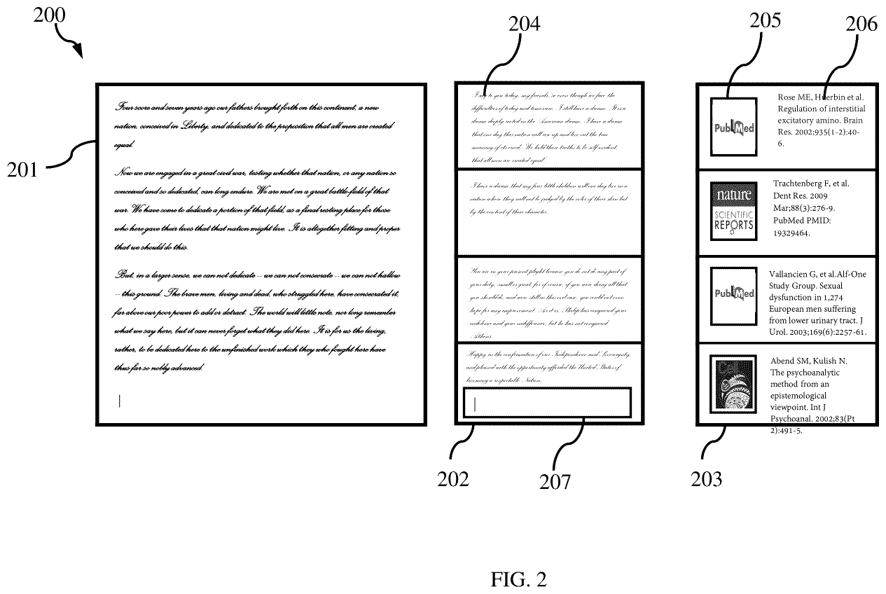

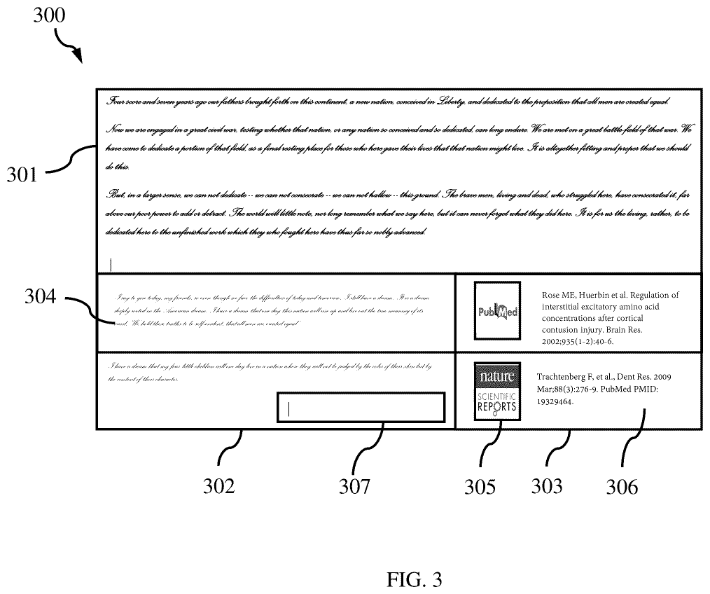

The regions of the GUI can be displayed and arranged in a variety of fashions. For example, the arrangement can be dictated by individual preferences of the user, convenience of displaying, and/or the information to be displayed. For example, FIG. 1 shows the alphanumeric text processing region 101, the AI-generated text region 102, and the reference list region 103 aligned next to each other, in a vertically-oriented layout. In certain embodiments, regions of the GUI may be displayed and presented to the user as a separate window (i.e., a separate window for each region), as shown in FIG. 2. For example, in this manner, separate windows for the alphanumeric text processing region 201, the AI-generated text region 202, and the reference list region 203 may be positioned and moved on the screen independently by a user, for convenience. As shown in FIG. 3, in certain embodiments, the alphanumeric text processing region 301, the AI-generated text region 302, and the reference list region 303 may be displayed according to a horizontal layout. In certain embodiments, different regions of the GUI may be displayed in a consolidated window, separated by lines or other visual cues, for example, as shown in FIG. 1 and FIG. 3. A graphical element (107) for entry of the received user query (e.g., a dialog box for freestyle text entry, or a drop-down menu, radio button list, or other graphical user interface element/widget with one or more predetermined entries presented for user selection) may appear inside (or outside) one or more of the at least three separate regions (e.g., inside the AI-generated text region of the GUI, and/or inside the reference list region of the GUI, and/or inside the alphanumeric text processing region of the GUI).

### [AI Generation of Alphanumeric Text]

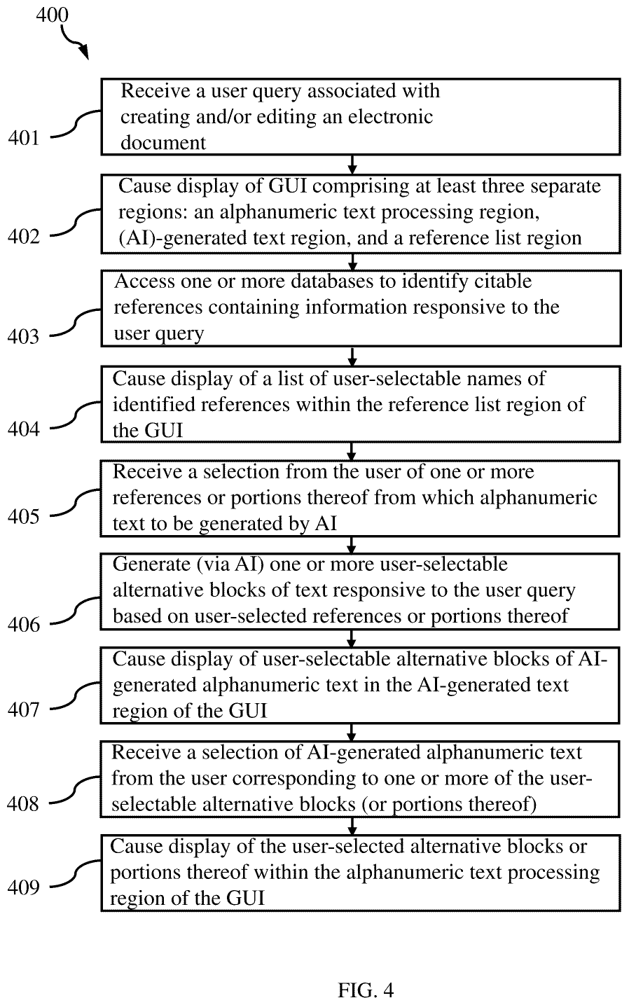

FIG. 4 provides mechanistic context of specific operational steps in an illustrative method 400 employing the GUI 100 (and, correspondingly, 200, 300, 500, 600, 700, 800, and 900) shown in the figures. Specifically, after receiving the user query 401 and causing display of the GUI 402, the processor accesses 403 one or more databases to identify one or more known, citable references containing information responsive to the query. The processor causes display 404 of a list of user-selectable name(s) of the one or more identified, known, citable references within the reference list region of the GUI 103. The user selects 405 one or more of the known, citable reference(s), or one or more portions thereof, from which one or more alternative blocks of alphanumeric text are to be generated in whole or in part by artificial intelligence (AI). The selection process may be done by identifying one or more cursor-location-associated mouse clicks, touchpad touches, or other input by the user made within the reference list region of the GUI.

After receiving user selection, the processor generates 406 one or more user-selectable alternative blocks of alphanumeric text in whole or in part by AI (AI-generated alphanumeric text) responsive to the user query, said generating based at least in part on the user-selected known, citable reference(s) or portion(s) thereof. The processor may cause display 407 of the one or more user-selectable alternative blocks of AI-generated alphanumeric text in the AI-generated text region 102 of the GUI.

A user selects 408 one or more of the user-selectable alternative block(s)—or one or more portion(s) thereof—of the AI-generated alphanumeric text. The selection process may be done by identifying one or more cursor-location-associated mouse clicks, touchpad touches, or other input by the user made within the reference list region of the GUI. In response to the selection, the processor may cause display 409 of the GUI (e.g., updated) with the one or more user-selected alternative block(s)—or the one or more user-selected portion(s) thereof—within the alphanumeric text processing region 101 of the GUI (e.g., copying and pasting of the AI-generated text into the electronic document in the word processing active drafting panel). The user may further edit the text in the text editor 101.

### [User Selects Multiple References to Produce a Single Block of AI-Generated Text]

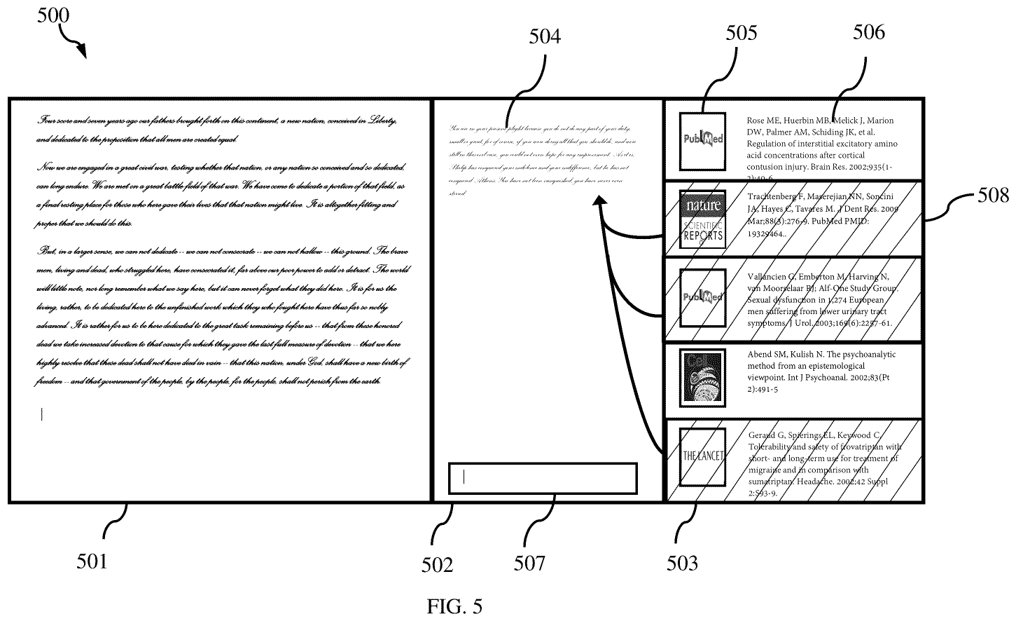

In certain embodiments, a user may choose to obtain a single block of AI-generated text based on all of a user-selected plurality of references displayed in the reference list region of the GUI. For example, a user may seek to synthesize content of multiple references. FIG. 5 shows a schematic of a GUI 500 in which a user has selected a plurality of the known, citable reference(s) 508 in the reference list region 503 of the GUI, as indicated in FIG. 5 with shading. The GUI may graphically identify the selected plurality of references, e.g., by highlighting or shading the selected names of the references in the reference list region of the GUI. The selection process may be performed either before or after the user inputs the user query 507. For example, there may be multiple queries, where a first query produces a list of relevant references and a second query narrows or adds to the list of references, or ranks/prioritizes the list by presenting certain references more prominently in the list. In certain embodiments, the processor may render and/or display a single block of AI-generated text 504 that has been generated based on all of the user-selected plurality of references. In certain embodiments, there may be rendered and/or displayed several alternative blocks of AI-generated text based on all of the user-selected plurality. In certain embodiments, rather than selecting which references to include, a user may select which references to exclude from the plurality of references that the AI-generated text will be based on. This may be convenient, for example, where the user seeks to exclude fewer references as compared to the number of references to be included (fewer clicks are required).

### [Multiple Blocks of AI-Generated Text Displayed for a Single Selected Reference]

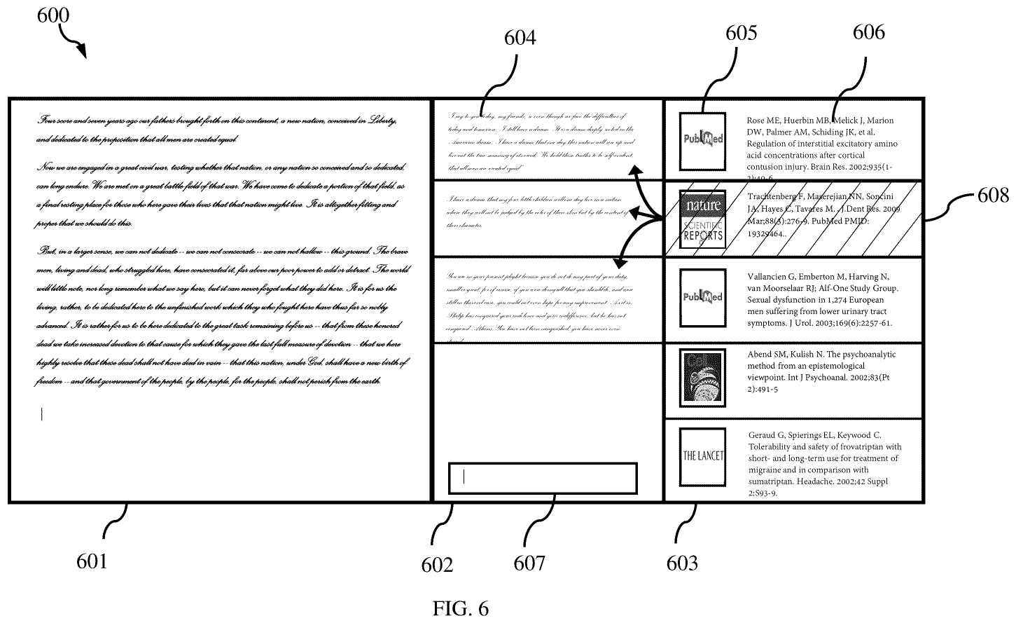

In certain embodiments, a user may seek to obtain a plurality of automatically-generated alternative AI-generated alphanumeric text blocks based on a selected reference from the list of references. For example, a user may look for response variations to choose from to find the best fit for the current content of the electronic document in the alphanumeric processing region. The best fit may be assessed, for example, as related to the context of the electronic document, its stylistic guidelines, length of a text block, or any combination thereof. FIG. 6 shows a schematic that represents a screenshot of a GUI 600 in which a user has selected a reference 608 in the reference list region 603 of the GUI. The selection process may be performed either before or after the user inputs the user query 607. In response to the user query entered via the user query widget 607, a plurality of user-selectable alternative blocks of AI-generated alphanumeric text 604 based (at least in part) on the user-selected reference are generated by the AI software and rendered and/or displayed by the processor in the AI-generated text region 602. In certain embodiments, a user may select the exact number of alternative blocks to be presented via a respective input in the user query 607. In certain embodiments, a user may select options for AI-generated alphanumeric text 604 via a respective input in the user query 607. For example, the options may include one or more of the following: level of formality of the text (e.g., formal, semi-formal, informal), level of compactness of the summary (e.g., very concise, moderately concise, or somewhat concise), and levels of details (detailed, moderately detailed, or somewhat detailed).

[Display Text from a Selected Reference and Generate AI-Text Block Based on a User-Selected Portion]

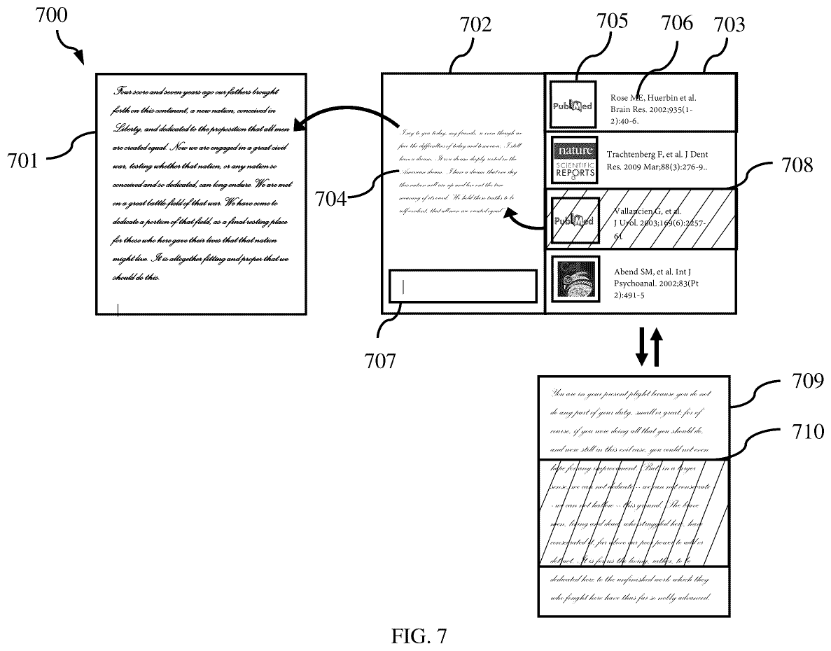

In certain embodiments, a user may seek to receive the AI-generated text output based only on a user-identified portion of text in a selected reference. For example, only the selected text may be relevant to a user query. The relevance may be, for example, contextual (e.g., other parts of the reference talk about the query-relevant information in a different context), terminology-based (e.g., other parts of the reference discuss the query-relevant terminology in a different interpretation), proximity-based (e.g., only specific parts of the reference that in a certain proximity to the specific part of the reference are relevant), or any combination thereof. Such text selection may enhance the accuracy of AI-generated text. FIG. 7 shows a schematic that represents a screenshot of a GUI 700 in which a user may select a reference from the list of references presented in the reference list region 703 of the GUI. Upon selection, text of the selected reference is displayed. In certain embodiments, the displayed text may be within a separate reference text displaying region 709 of the GUI. In certain embodiments, the text displaying region 709 may be displayed instead of the reference list region 703 of the GUI. The user may select one or more portions of the reference text by highlighting 710 and/or otherwise graphically indicating said portion(s). The selection process may be done by identifying one or more cursor-location-associated mouse clicks, touchpad touches, or other input by the user made within the text displaying region 709 of the GUI.

In certain embodiments, each of one or more block(s) of alphanumeric text may be generated based at least in part on the user query entered via the user query widget 707 and the selected text portion(s) 710. In certain embodiments where multiple blocks of text are generated, the text blocks in the AI-generated text region may be ordered in the order of appearance of the related selected text portions in the reference text 709. In certain embodiments, the AI-generated text in the AI-generated text region may be ordered chronologically (e.g., in the order the user selected text portions in the reference text). In certain embodiments, each alternative block of alphanumeric text may be generated based at least in part on the user query and all of the selected text portions. In certain embodiments, multiple alternative blocks of alphanumeric text may be generated based at least in part on the user query and a single selected text portion.

### [Rating AI-Generated Text and Feedback]

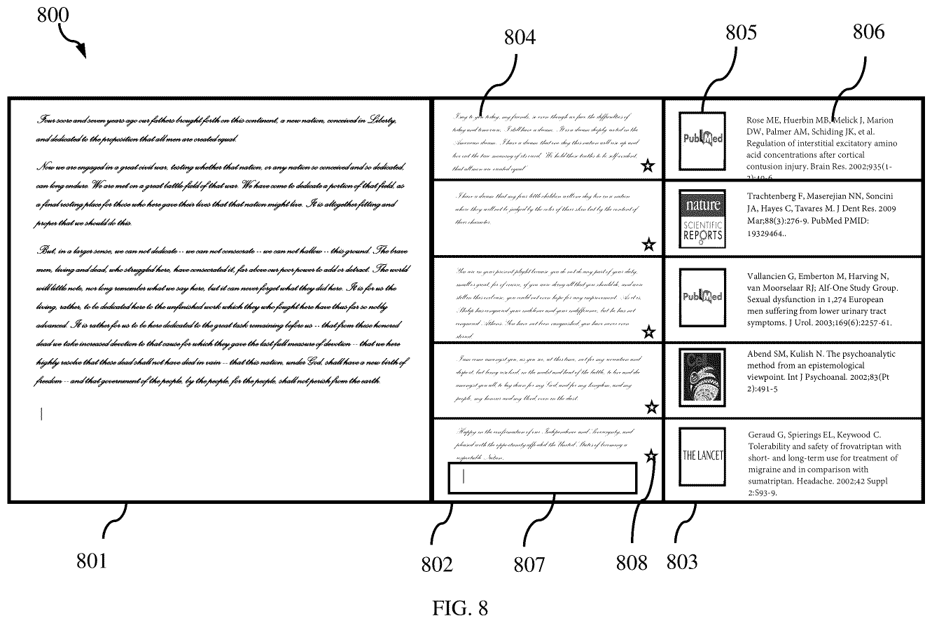

In certain embodiments, a user may rate the AI-generated text output. For example, a user may seek to provide feedback on the AI-generated alphanumeric text for purposes of training the software for future use. The feedback may improve, for example, the accuracy of the AI-generated alphanumeric text as related to a user-submitted query. FIG. 8 shows a schematic that represents a GUI 800 in which the AI-generated alphanumeric text is rated 808 by the user. Rating may be represented using any suitable scale, for example binary (liked or not liked), qualitative (e.g., very good, good, moderate, bad, or very bad), or quantitative (e.g., a score, such as on a scale of 1-100). In certain embodiments, in response to the user rating, the AI-generated blocks of text that are unranked and/or ranked with the lowest scores are substituted with new AI-generated blocks of text responsive to the same user query, e.g., the new blocks produced in light of the ranking/rating feedback received.

In certain embodiments, the feedback from the rating process may be incorporated into the generative AI software settings, for example, in the form of reinforcement learning from human feedback (RLHF). In certain embodiments, the feedback can be configured by the user. In certain embodiments, the rating affects all subsequent queries, but only in the current session. In certain embodiments, the rating may affect only certain properties of the AI-generated text, like level of compactness, level of details, and length of the AI-generated text block. In certain embodiments, the feedback can be non-linear and/or weighted with respect to the rating scale.

### [Searching and Saving Text Capabilities]

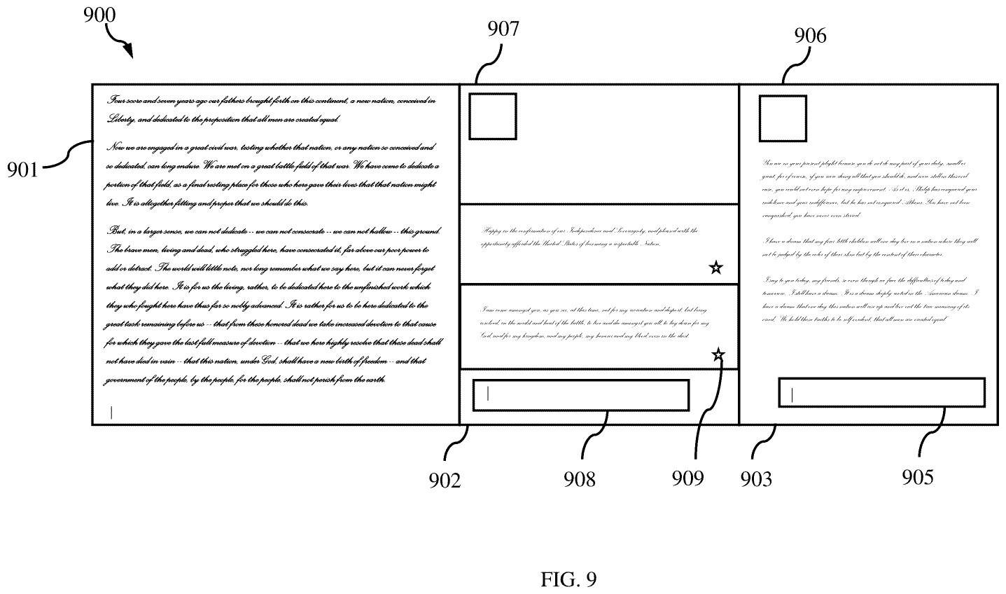

In certain embodiments, a user may search the text of the user-selected reference within a window/panel of the GUI (or within a window rendered and displayed elsewhere on the screen). For example, a user may seek to quickly identify relevant portions of text that, for example, contain specific keywords. The relevant portions of text may be needed to provide proper context for the subsequent text generation by the AI software and/or check the accuracy of the AI-generated text. In certain embodiments, a user may save the identified alphanumeric text portions in both the artificial intelligence (AI)-generated text region and the reference list region. For example, a user may seek to save the identified alphanumeric text portions for the later use without disturbing the electronic document in the word processing region. FIG. 9 shows a schematic that represents a screenshot of a GUI 900 in which the text of a user-selected reference is searched in response to a user query and the identified alphanumeric text portions can be saved in both the artificial intelligence (AI)-generated text region and the reference list region of the GUI. The user may search the reference using a search query entered via a dialog box or other widget 905. The identified alphanumeric text portions may be saved using save queries in both the artificial intelligence (AI)-generated text region 907 and the reference list region 906 (which is shown here with the searchable text of a single selected reference rather than a list of reference names). The search query may comprise, for example, alphanumeric text in the form of a question or command received via a dialog box, and/or a selection of one or more entries of a drop-down menu, radio button list, or other graphical user interface element/widget. The save query may comprise, for example, alphanumeric text in the form of a question or command received via a dialog box, and/or a selection of one or more entries of a drop-down menu, radio button list, or other graphical user interface element/widget.

### [Software Used to Generating AI Text Blocks]

In certain embodiments, AI used to generate alphanumeric text responsive to the user query may comprise extractive question answering (Extractive QA) software.

In certain embodiments, AI used to generate alphanumeric text responsive to the user query may comprise natural language processing (NLP) software (e.g., including but not limited to generative AI software, e.g., ChatGPT and/or proprietary generative AI software).

In certain embodiments, AI used to generate alphanumeric text responsive to the user query may comprise (and/or utilize) one or more large language models (LLMs) [e.g., wherein the one or more LLMs comprise(s) one or more members selected from the group consisting of: BERT (Google) (or other transformer-based models), Falcon 40B, Galactica, GPT-3 (Generative Pre-trained Transformer, OpenAI), GPT-3.5 (OpenAI), GPT-4 (OpenAI), LaMDA (language model for dialogue applications, Google), Llama (large language model Meta AI) (Meta), Orca LLM (Microsoft), PaLM (Pathways Language Model), Phi-1 (Microsoft), StableLM (Stability AI), BLOOM (Hugging Face), ROBERTa (Meta), XLM-ROBERTa (Meta), NeMO LLM (Nvidia), XLNet (Google), Generate (Cohere), GLM-130B (Hugging Face), and Claude (Anthropic)] [e.g., wherein the one or more LLMs comprise(s) one or more members selected from the group consisting of an autoregressive LLM, autoencoding LLM, encoder-decoder LLM, bidirectional LLM, Fine-tuned LLMs, and multimodal LLMs].

### [Queries Specific to CSRs]

In certain embodiments, the electronic document being created and/or edited in the word processing panel 101 of the GUI 100 is a clinical study report (CSR).

In certain embodiments, a user query is targeted to extract at least one of the following as related to CSR: a protocol number or a study number; number and name of each clinical study site or center; description of style guidelines; clinical study report project timeline and critical dates; name, title, and contact information for sponsor's representative who will approve and sign CSR; name, title, and contact information for Principal Investigator who will sign the CSR; description of naming conventions for clinical study report files; screening logs for subject disposition; case report forms of subjects who had serious adverse events; milestone study period dates: dates when first subject enrolled, last subject enrolled, and last subject completed study; sample study-specific master Informed Consent Forms for protocol and all amendments; safety narratives; statistical analysis plan; pharmacokinetics report; pharmacodynamic report; toxicology report; immunogenicity report; list of references (abstracts or manuscripts) from publications derived from clinical study data; original clinical study protocols and all amendments; chairperson and address of Steering Committee; name of the company that managed the clinical trial supply; names and addresses of laboratory facilities used; laboratory certificates and normal ranges for all laboratories; list of investigational drug batch numbers and list of subjects (by subject number) receiving each batch of investigational drug; list of protocol violations and/or deviations; list of investigators and study personnel, mailing and e-mail addresses, telephone and fax numbers; list of names and contact information of sponsor's personnel who participated in the clinical study: medical monitor, biostatistician, and clinical research associate(s).

### Various Embodiments

It is contemplated that systems, architectures, devices, methods, and processes of the claimed invention encompass variations and adaptations developed using information from the embodiments described herein. Adaptation and/or modification of the systems, architectures, devices, methods, and processes described herein may be performed, as contemplated by this description.

Throughout the description, where articles, devices, systems, and architectures are described as having, including, or comprising specific components, or where processes and methods are described as having, including, or comprising specific steps, it is contemplated that, additionally, there are articles, devices, systems, and architectures of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Documents are incorporated herein by reference as noted.

Headers are provided for the convenience of the reader—the presence and/or placement of a header is not intended to limit the scope of the subject matter described herein.

### Computer Software, Computer System, and Network Environment

Certain embodiments described herein make use of computer algorithms in the form of software instructions executed by a computer processor. In certain embodiments, the software instructions include a machine learning module, also referred to herein as artificial intelligence software. As used herein, a machine learning module refers to a computer implemented process (e.g., a software function) that implements one or more specific machine learning techniques, e.g., artificial neural networks (ANNs), e.g., convolutional neural networks (CNNs), e.g., recursive neural networks, e.g., recurrent neural networks such as long short-term memory (LSTM) or Bilateral long short-term memory (Bi-LSTM), random forest, decision trees, support vector machines, and the like, in order to determine, for a given input, one or more output values.

In certain embodiments, the methods and systems described herein make use of natural language processing (NLP) software, including but not limited to generative AI software (e.g., ChatGPT and/or proprietary generative AI software). In certain embodiments, this NLP software makes use of one or more large language models (LLMs). In certain embodiments, the one or more LLMs may be partially or wholly proprietary. In certain embodiments, the one or more LLMs may include one or more of the following known LLMs: BERT (Google) (or other transformer-based models), Falcon 40B, Galactica, GPT-3 (Generative Pre-trained Transformer, OpenAI), GPT-3.5 (OpenAI), GPT-4 (OpenAI), LaMDA (language model for dialogue applications, Google), Llama (large language model Meta AI) (Meta), Orca LLM (Microsoft), PaLM (Pathways Language Model), Phi-1 (Microsoft), StableLM (Stability AI), BLOOM (Hugging Face), ROBERTa (Meta), XLM-ROBERTa (Meta), NeMO LLM (Nvidia), XLNet (Google), Generate (Cohere), GLM-130B (Hugging Face), Claude (Anthropic). The one or more LLMs may include one or more autoregressive LLMs, autoencoding LLMs, encoder-decoder LLMs, bidirectional LLMs, Fine-tuned LLMs, and/or multimodal LLMs.

In certain embodiments, machine learning modules implementing machine learning techniques are trained, for example using datasets that include categories of data described herein (e.g. journal articles, scientific texts, technical databases, experimental data, and the like). Such training may be used to determine various parameters of machine learning algorithms implemented by a machine learning module, such as weights associated with layers in neural networks. In certain embodiments, once a machine learning module is trained, e.g., to accomplish a specific task such as producing one or more blocks of AI-generated text based on a user query and one or more user-selected references), values of determined parameters are fixed and the (e.g., unchanging, static) machine learning module is used to process new data (e.g., different from the training data) and accomplish its trained task without further updates to its parameters (e.g., the machine learning module does not receive feedback and/or updates). In certain embodiments, machine learning modules may receive feedback, e.g., based on user review of accuracy, and such feedback may be used as additional training data, to dynamically update the machine learning module. In certain embodiments, two or more machine learning modules may be combined and implemented as a single module and/or a single software application. In certain embodiments, two or more machine learning modules may also be implemented separately, e.g., as separate software applications. A machine learning module may be software and/or hardware. For example, a machine learning module may be implemented entirely as software, or certain functions of a ANN module may be carried out via specialized hardware (e.g., via an application specific integrated circuit (ASIC)).

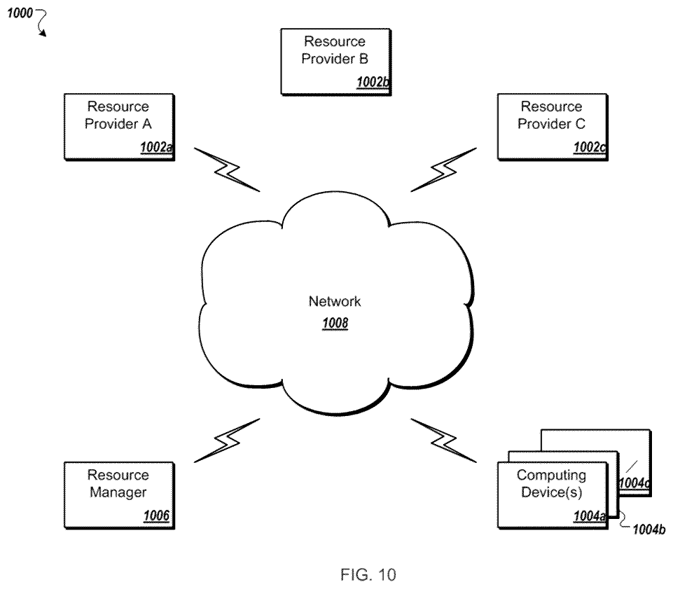

As shown in FIG. 10, an implementation of a network environment 1000 for use in providing systems, methods, and architectures as described herein is shown and described. In brief overview, referring now to FIG. 10, a block diagram of an exemplary cloud computing environment 1000 is shown and described. The cloud computing environment 1000 may include one or more resource providers 1002a, 1002b, 1002c (collectively, 1002). Each resource provider 1002 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1002 may be connected to any other resource provider 1002 in the cloud computing environment 1000. In some implementations, the resource providers 1002 may be connected over a computer network 1008. Each resource provider 1002 may be connected to one or more computing device 1004a, 1004b, 1004c (collectively, 1004), over the computer network 1008.

The cloud computing environment 1000 may include a resource manager 1006. The resource manager 1006 may be connected to the resource providers 1002 and the computing devices 1004 over the computer network 1008. In some implementations, the resource manager 1006 may facilitate the provision of computing resources by one or more resource providers 1002 to one or more computing devices 1004. The resource manager 1006 may receive a request for a computing resource from a particular computing device 1004. The resource manager 1006 may identify one or more resource providers 1002 capable of providing the computing resource requested by the computing device 1004. The resource manager 1006 may select a resource provider 1002 to provide the computing resource. The resource manager 1006 may facilitate a connection between the resource provider 1002 and a particular computing device 1004. In some implementations, the resource manager 1006 may establish a connection between a particular resource provider 1002 and a particular computing device 1004. In some implementations, the resource manager 1006 may redirect a particular computing device 1004 to a particular resource provider 1002 with the requested computing resource.

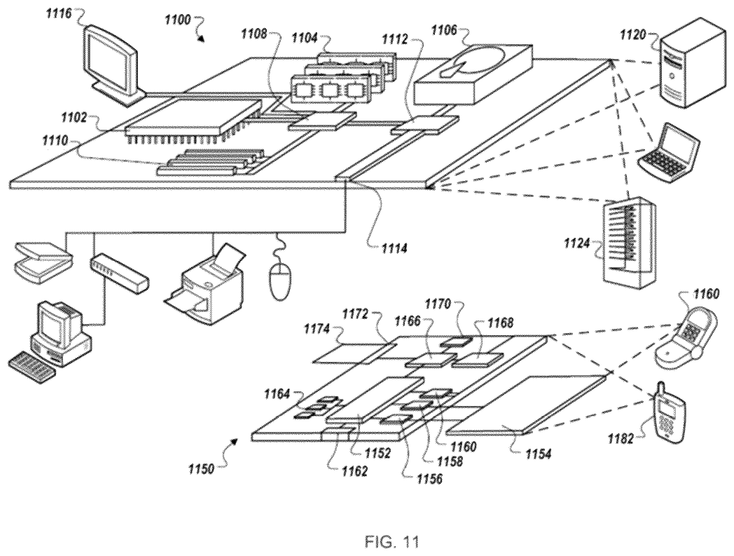

FIG. 11 shows an example of a computing device 1100 and a mobile computing device 1150 that can be used to implement the methods and systems described herein. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1100 includes a processor 1102, a memory 1104, a storage device 1106, a high-speed interface 1108 connecting to the memory 1104 and multiple high-speed expansion ports 1110, and a low-speed interface 1112 connecting to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as a display 1116 coupled to the high-speed interface 1108. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (one or more) of any number of computing devices (one or more). Furthermore, where a function is described as being performed by “a processor”, this encompasses embodiments wherein the function is performed by any number of processors (one or more) of any number of computing devices (one or more) (e.g., in a distributed computing system).

The memory 1104 stores information within the computing device 1100. In some implementations, the memory 1104 is a volatile memory unit or units. In some implementations, the memory 1104 is a non-volatile memory unit or units. The memory 1104 may also be another form of computer-readable medium, such as a magnetic or optical disk.

The storage device 1106 is capable of providing mass storage for the computing device 1100. In some implementations, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1102), perform one or more methods, such as those described above. The instructions can also be stored by one or more storage devices such as computer— or machine-readable mediums (for example, the memory 1104, the storage device 1106, or memory on the processor 1102).

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards (not shown). In the implementation, the low-speed interface 1112 is coupled to the storage device 1106 and the low-speed expansion port 1114. The low-speed expansion port 1114, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. In addition, it may be implemented in a personal computer such as a laptop computer 1122. It may also be implemented as part of a rack server system 1124. Alternatively, components from the computing device 1100 may be combined with other components in a mobile device (not shown), such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152, a memory 1164, an input/output device such as a display 1154, a communication interface 1166, and a transceiver 1168, among other components. The mobile computing device 1150 may also be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate.

The processor 1152 can execute instructions within the mobile computing device 1150, including instructions stored in the memory 1164. The processor 1152 may be implemented as a chipset of chips that include separate and multiple analog and digital processors. The processor 1152 may provide, for example, for coordination of the other components of the mobile computing device 1150, such as control of user interfaces, applications run by the mobile computing device 1150, and wireless communication by the mobile computing device 1150.

The processor 1152 may communicate with a user through a control interface 1158 and a display interface 1156 coupled to the display 1154. The display 1154 may be, for example, a TFT (Thin-Film-Transistor Liquid Crystal Display) display or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile computing device 1150 with other devices. The external interface 1162 may provide, for example, for wired communication in some implementations, or for wireless communication in other implementations, and multiple interfaces may also be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may also be provided and connected to the mobile computing device 1150 through an expansion interface 1172, which may include, for example, a SIMM (Single In Line Memory Module) card interface. The expansion memory 1174 may provide extra storage space for the mobile computing device 1150, or may also store applications or other information for the mobile computing device 1150. Specifically, the expansion memory 1174 may include instructions to carry out or supplement the processes described above, and may include secure information also. Thus, for example, the expansion memory 1174 may be provide as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 1152), perform one or more methods, such as those described above. The instructions can also be stored by one or more storage devices, such as one or more computer- or machine-readable mediums (for example, the memory 1164, the expansion memory 1174, or memory on the processor 1152). In some implementations, the instructions can be received in a propagated signal, for example, over the transceiver 1168 or the external interface 1162.

The mobile computing device 1150 may communicate wirelessly through the communication interface 1166, which may include digital signal processing circuitry where necessary. The communication interface 1166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1168 using a radio-frequency. In addition, short-range communication may occur, such as using a Bluetooth®, Wi-Fi™, or other such transceiver (not shown). In addition, a GPS (Global Positioning System) receiver module 1170 may provide additional navigation- and location-related wireless data to the mobile computing device 1150, which may be used as appropriate by applications running on the mobile computing device 1150.

The mobile computing device 1150 may also communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may also include sound generated by applications operating on the mobile computing device 1150.

The mobile computing device 1150 may be implemented in a number of different forms, as shown in the figure. For example, it may be implemented as a cellular telephone 1180. It may also be implemented as part of a smart-phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, certain modules described herein can be separated, combined or incorporated into single or combined modules. Any modules depicted in the figures are not intended to limit the systems described herein to the software architectures shown therein.

Elements of different implementations described herein may be combined to form other implementations not specifically set forth above. Elements may be left out of the processes, computer programs, databases, etc. described herein without adversely affecting their operation. In addition, the logic flows depicted in the figures do not require the particular order shown, or sequential order, to achieve desirable results. Various separate elements may be combined into one or more individual elements to perform the functions described herein.

While the present invention has been particularly shown and described with reference to specific preferred embodiments, it should be understood by those skilled in the art that various changes in form and detail may be made therein without departing from the spirit and scope of the present invention as defined by the appended claims.

### Illustrative Embodiment

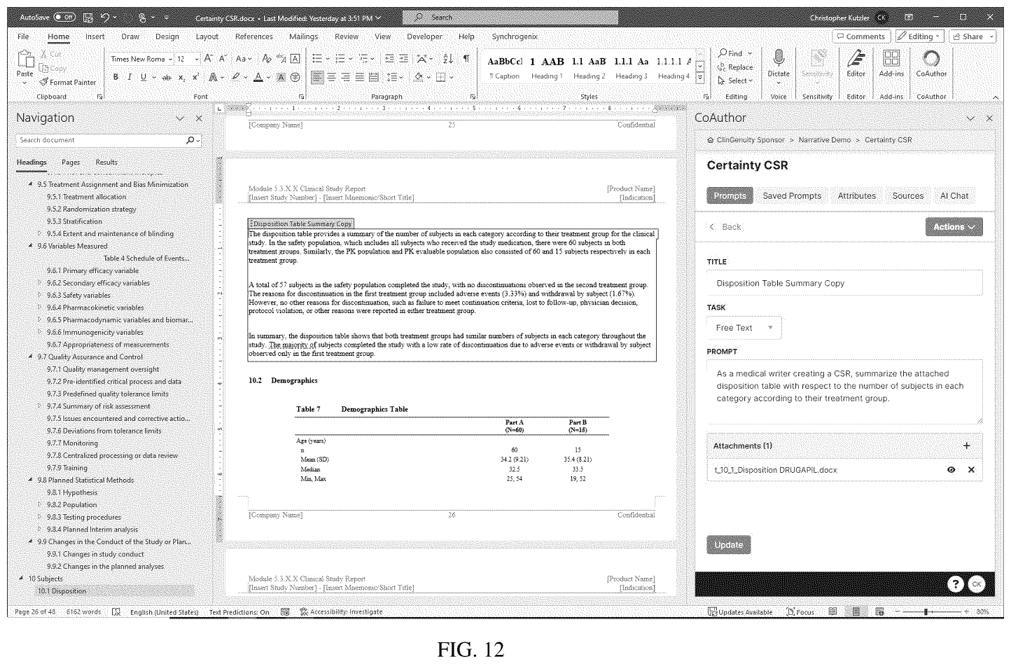

FIGS. 12 to 20 show screenshots of graphical user interfaces (GUIs, e.g., windows) of an illustrative system for providing automated, real-time interactive assistance to a user creating an electronic document via a GUI, referred to herein as Certara CoAuthor. The system makes use of a Generative Pre-Trained Transformer (GPT) platform to provide a secure, client-specific solution for generative artificial intelligence (gen AI) data integration and analytics. The GPT platform is referred to herein as Certara.AI. It is a secure, client-specific gen AI platform with a modular and extensible application (app) suite. Certara.AI has built-in GPTs to allow for the deployment of specialized GPT AI technologies in a secure client-specific manner. Client documents, client databases, and/or reference data can be accessed and utilized by the apps operating on the platform.

FIG. 12 shows a GUI of Certara CoAuthor, a secure, client-specific, validated, compliant regulatory writing platform that combines structured content authoring and generative AI to enable regulatory writers to work more efficiently. It is a tool for expert regulatory writers and is engineered as a “human in the loop” platform for their use, based on their feedback. Certara CoAuthor uses a retrieval augmented generation (RAG) architecture, tested and developed based on feedback from expert writers. It is a client-specific gen AI platform, with no data leakage to public models. The gen AI platform combines gen AI, SCA, Redaction, and eCTD (electronic common technical document) templates. The eCTD template suite provides validation and compliance and are annually updated by experts. Certara CoAuthor features automated gen AI with pre-engineered prompt variables.

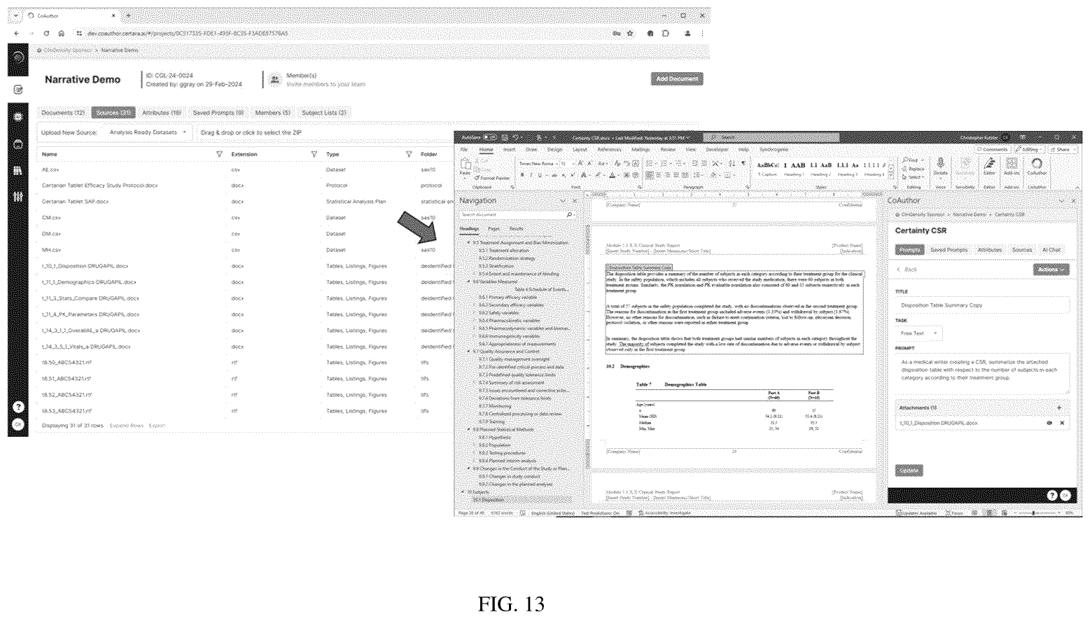

FIG. 13 shows analysis-ready datasets (sources) available in the creation of the document shown in the GUI at the right of FIG. 13 and in FIG. 12. The “CoAuthor” pane of this GUI shows active prompts, and indication of task type, and related documents (Attachments). Also tabbed are saved prompts, attributes, sources on which the generated text is based, and an AI chat feature. The central pane of the GUI shows the active document with generated text outlined in a colored box.

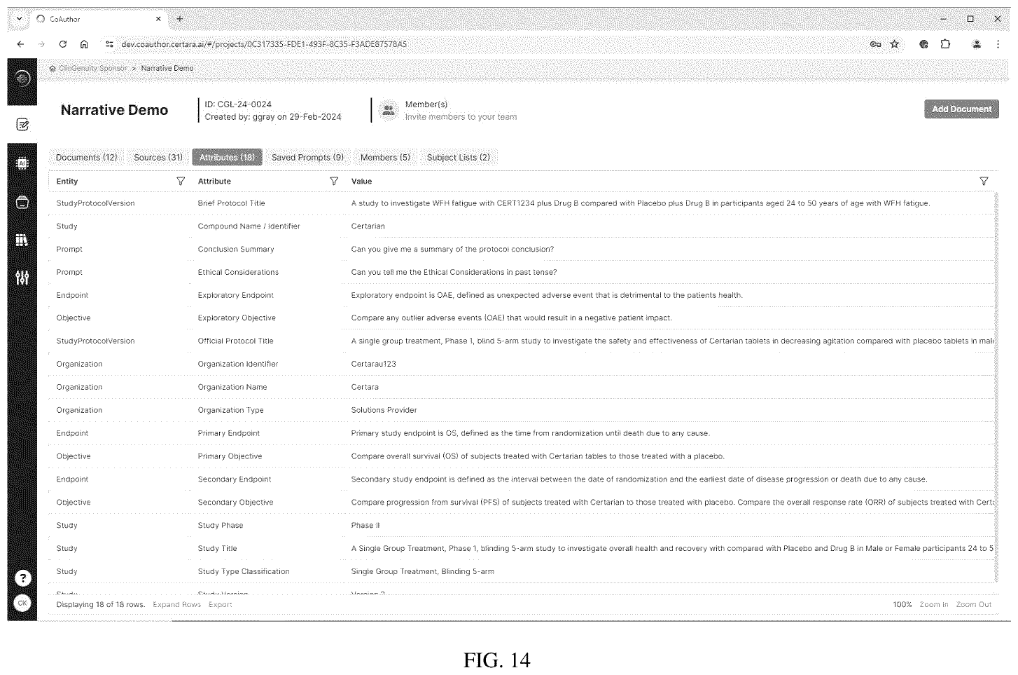

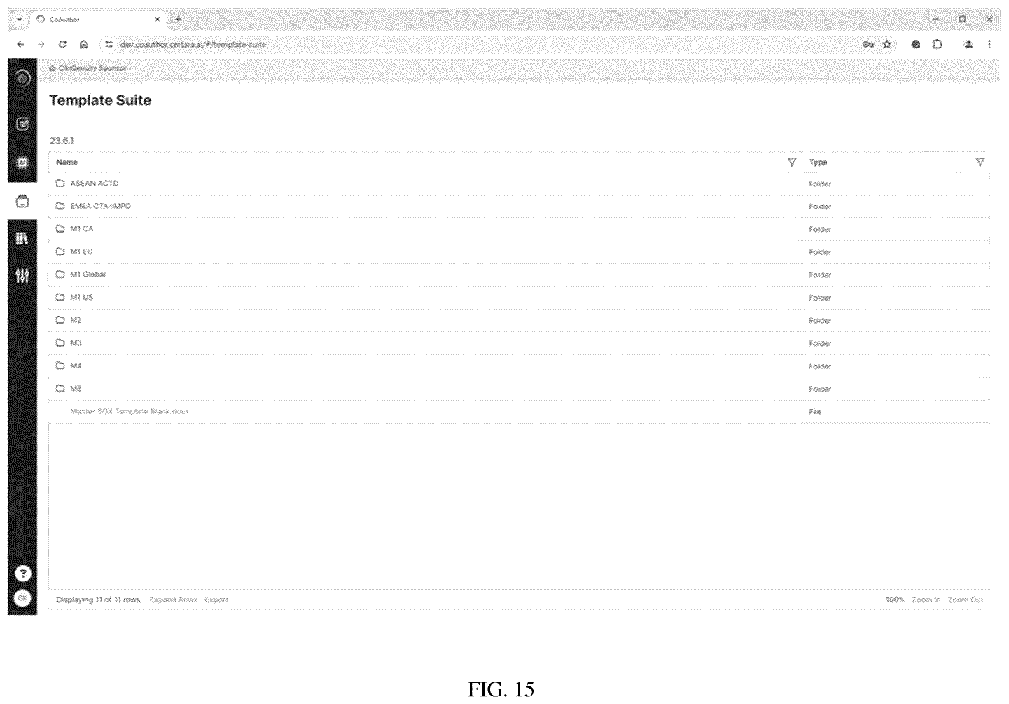

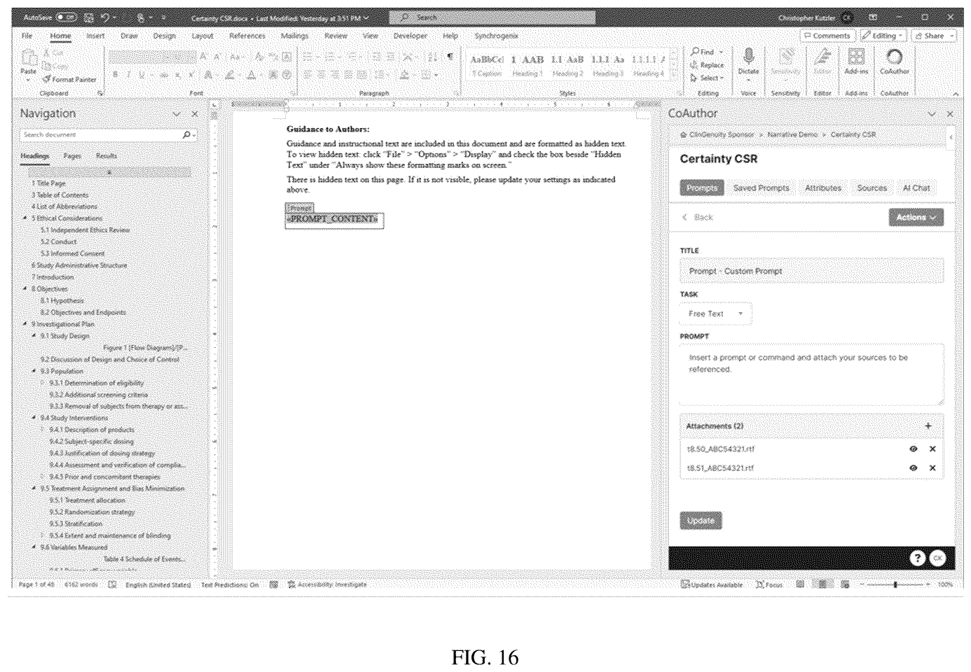

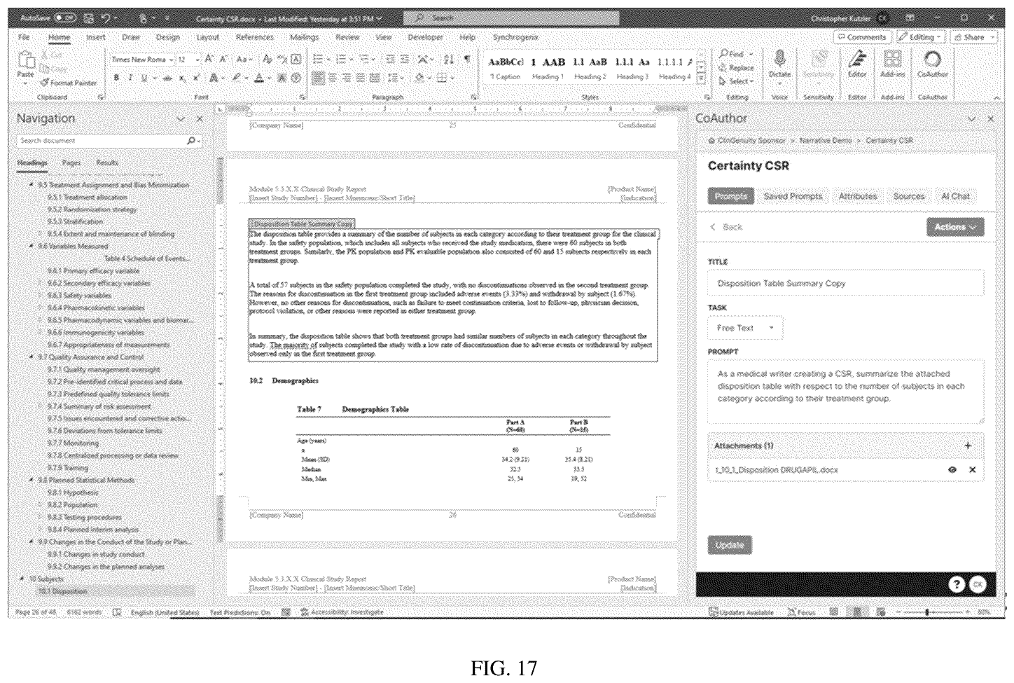

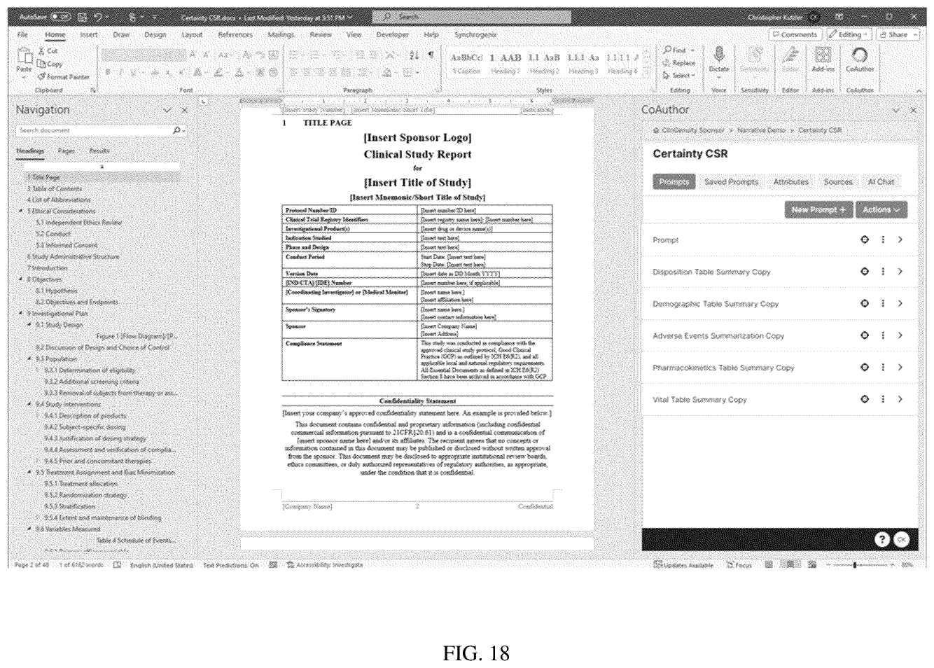

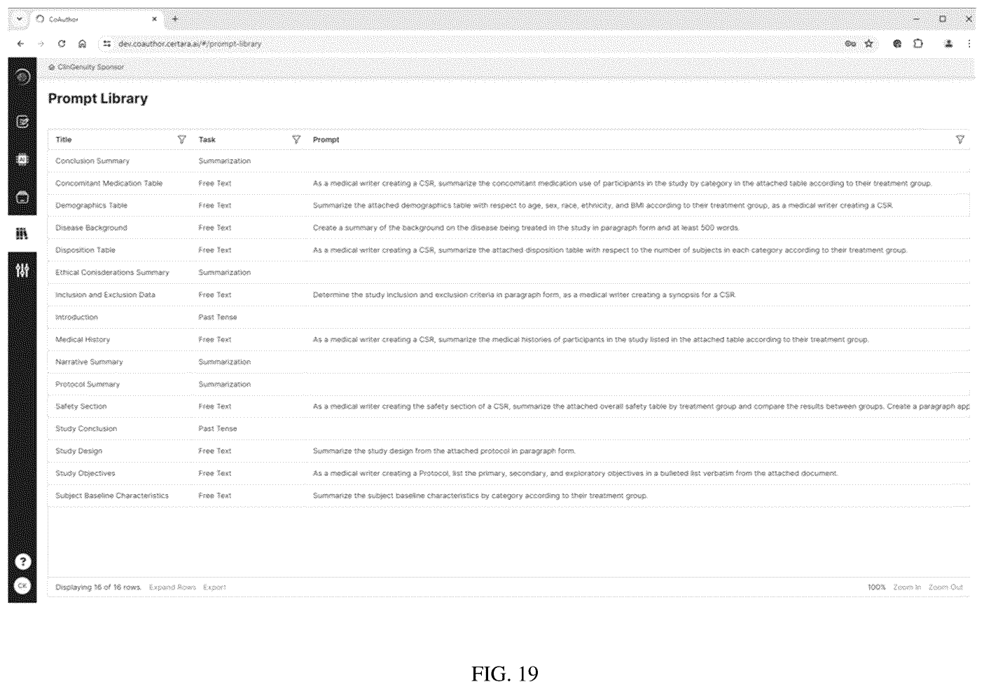

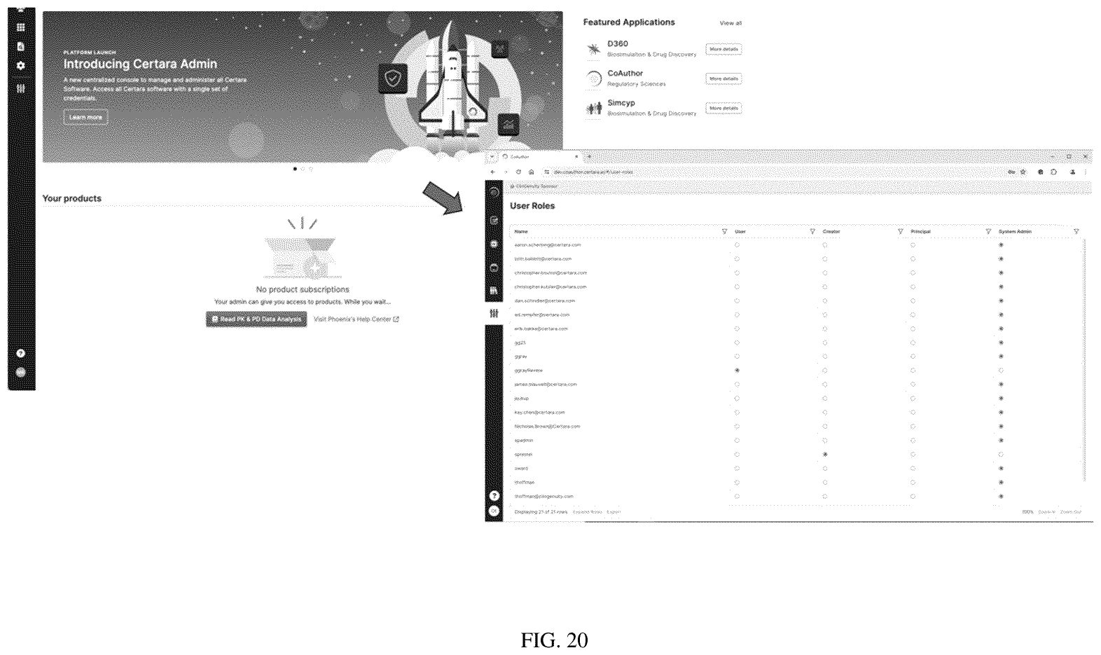

FIG. 14 shows the attributes tab referenced above, illustrating structured content authoring driven with variables. FIG. 15 shows an illustrative eCTD template suite for use in the Certara CoAuthor system. FIG. 16 illustrates how prompt variables are introduced in the illustrative Certara CoAuthor system. FIG. 17 illustrates generation of template driven content with prompt variables in the illustrative system. FIG. 18 illustrates use of a “Generate All” feature that builds a draft for the regulatory writer and presents a panel at right for managing/executing prompts. FIG. 19 illustrates regulatory writing specialized saved prompts (see selected tab in pane at right). FIG. 20 illustrates the prompts in the prompt library may be reused across different projects.

1. A method for providing automated, real-time interactive assistance to a user creating an electronic document via a graphical user interface (GUI), the method comprising:
receiving, by a processor of a computing device, a user query;
rendering, and/or displaying on a screen, the graphical user interface (GUI), said GUI comprising at least three separate regions, said at least three regions comprising:
an alphanumeric text processing region for use by the user in creating and/or editing content of the electronic document within said alphanumeric text processing region,
an artificial intelligence (AI)-generated text region for presenting to the user, in response to the user query, one or more user-selectable alternative blocks of alphanumeric text generated in whole or in part by artificial intelligence (AI), each alterative block of alphanumeric text generated based at least in part on the user query and one or more known, citable reference(s) and selectable by the user for presentation within the alphanumeric text processing region, and
a reference list region for presenting to the user, in response to a user query, user-selectable name(s) of one or more known, citable references for possible selection by the user;
accessing, by the processor, one or more databases to identify one or more known, citable references containing information responsive to the query;
rendering, and/or displaying on the screen, by the processor, a list of user-selectable name(s) of the one or more identified, known, citable references within the reference list region of the GUI;
receiving, by the processor, a selection from the user corresponding to one or more of the known, citable reference(s)—or one or more portions thereof—from which one or more alternative blocks of alphanumeric text are to be generated in whole or in part by artificial intelligence (AI);
generating, by the processor, one or more user-selectable alternative blocks of alphanumeric text in whole or in part by artificial intelligence (AI) (AI-generated alphanumeric text) responsive to the user query, said generating based at least in part on the user-selected known, citable reference(s) or portion(s) thereof;
rendering, and/or displaying on the screen, by the processor, the one or more user-selectable alternative blocks of AI-generated alphanumeric text in the AI-generated text region of the GUI;
receiving, by the processor, a selection from the user corresponding to one or more of the user-selectable alternative block(s)—or one or more portion(s) thereof—of AI-generated alphanumeric text; and
in response to selection by the user of one or more of the alternative block(s) of AI-generated alphanumeric text, or portion(s) thereof, rendering, and/or displaying on the screen, by the processor, the GUI with the one or more user-selected alternative block(s)—or the one or more user-selected portion(s) thereof—within the alphanumeric text processing region of the GUI.

2. The method of claim 1, wherein the user query elicits a plurality of known, citable references, and wherein the method comprises:
generating, by the processor, at least one user-selectable alternative block of AI-generated alphanumeric text responsive to the query for each of the known, citable references;
rendering, and/or displaying on the screen, by the processor, the list of user-selectable names of the plurality of known references in the reference list region of the GUI; and
rendering and/or displaying on the screen, by the processor, the plurality of user-selectable alternative blocks of AI-generated alphanumeric text in the AI-generated text region of the GUI,
wherein each said reference name is rendered and/or displayed in the GUI in graphical proximity to the corresponding user-selectable alternative block of AI-generated alphanumeric text.

3. The method of claim 1, comprising:
receiving, by the processor, a selection from the user corresponding to a selected plurality of the known, citable reference(s);
generating, by the processor, a user-selectable block of AI-generated alphanumeric text responsive to the user query and based on all of the selected plurality of known, citable references; and
rendering, and/or displaying on the screen, by the processor, the user-selectable block of AI-generated alphanumeric text in the AI-generated text region of the GUI.

4. The method of claim 1, comprising:
generating, by the processor, for each user-selected reference in the reference list region of the GUI, a plurality of user-selectable alternative blocks of AI-generated alphanumeric text responsive to the user query and based on the user-selected reference; and
rendering, and/or displaying on the screen, by the processor, the user-selectable plurality of blocks of AI-generated alphanumeric text in the AI-generated text region of the GUI.

5. The method of claim 1, comprising:
rendering, and/or displaying on the screen, text from a user-selected reference from the reference list;
identifying, by the processor, a user-identified portion of the rendered and/or displayed text from the user-selected reference that is highlighted and/or otherwise graphically indicated by the user;
generating, by the processor, one or more user-selectable blocks of AI-generated alphanumeric text responsive to the user query and based on the user-identified portion of the rendered and/or displayed text; and
rendering, and/or displaying on the screen, by the processor, the one or more user-selectable blocks of AI-generated alphanumeric text in the AI-generated text region of the GUI.

6. The method of claim 1, the method comprising:
rendering, and/or displaying on a screen, a graphical element for entry of the received user query in the graphical user interface (GUI).

7. The method of claim 1, wherein generating, by the processor, the one or more user-selectable alternative blocks of AI-generated alphanumeric text responsive to the user query comprises using extractive question answering (Extractive QA) software.

8. The method of claim 1, wherein generating, by the processor, the one or more user-selectable alternative blocks of AI-generated alphanumeric text responsive to the user query comprises using natural language processing (NLP) software.

9. The method of claim 1, wherein generating, by the processor, the one or more user-selectable alternative blocks of AI-generated alphanumeric text responsive to the user query comprises using one or more large language models (LLMs).

10. The method of claim 1, wherein the electronic document is a clinical study report (CSR).

11. A system comprising a processor of a computing device and memory having instructions stored thereon, which, when executed by the processor, cause the processor to perform the method of claim 1.
